(19) United States
(12) Patent Application Publication
(10) Pub. No.: US 2008/0000835 A1
(43) Pub. Date: Jan. 3, 2008

(54) Hemodialysis methods and apparatus

(75) Inventor: Brooks Edward Rogers, Westford, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: FRESENIUS MEDICAL CARE NORTH AMERICA, Lexington, MA (US)

(21) Appl. No.: 11/436,891

(22) Filed: May 17, 2006

Related U.S. Application Data
(60) Provisional application No. 60/682,359, filed on May 17, 2005.

(51) Int. Cl. B01D 61/24; B01D 61/26; B01D 61/28

(52) U.S. Cl. 210/647; 210/744; 210/96.2

(57) ABSTRACT

Various methods and apparatus are provided for the administration, control, and display of dialysate constituents, particularly, for example, the acid and bicarbonate constituents, in order to achieve more physiologically desirable proportions of sodium and total base buffer and, more generally, more physiologically desirable dialysate.

### CROSS-REFERENCE TO RELATED APPLICATIONS

The pending application claims priority to U.S. Provisional Application Ser. No. 60/682,359 filed on May 17, 2005, the teachings of which are incorporated by reference herein.

### BACKGROUND OF THE INVENTION

The present invention relates to methods and apparatus for hemodialysis and, in particular, to methods and apparatus for metering dialysate constituents used in production of dialysate for hemodialysis.

Hemodialysis treatment supplements or replaces the function of the kidneys, which normally serve as the body's natural filtration system. Through the use of a blood filter and a chemical solution known as dialysate, the treatment removes waste products and excess fluids from a patient's blood, while maintaining its proper chemical balance. The apparatus used for the treatment, e.g., the hemodialysis machine, is typically “hooked to” the patient, extending the flow of the bloodstream through the filter and returning the cleaned blood to the patient, all in real-time.

The dialysate is typically produced (or mixed) in real-time by the hemodialysis machines. Among the consumables used for this are three constituents: water, an acid concentrate stream, and a bicarbonate concentrate stream. These are usually supplied in a liquid form via jugs or other containers that can be inserted by health care personnel as a patient treatment session begins. Alternatively and increasingly, the acid and bicarbonate constituents can be supplied in solid form.

While current methods and apparatus for hemodialysis have proven effective, especially, those from the assignee hereof, there remains room for advancement. Accordingly, an object of this invention is to provide improved methods and apparatus for hemodialysis.

A more particular object is to provide improved such methods and apparatus for metering dialysate constituents used in production of dialysate for hemodialysis.

A further object is to provide improved such methods and apparatus for prescribing and/or administering dialysate.

Still a further object of the invention is to provide such methods and apparatus as can be used with liquid and dry mix dialysate constituents alike.

Yet still a further object of the invention is to provide improved such methods and apparatus as can be implemented at low cost and without undue capital expenditure.

### SUMMARY OF THE INVENTION

The foregoing are among the objects attained by the invention which provides, inter alia, improved methods and apparatus for hemodialysis that administer and/or permit administration of dialysate based on total base buffer (e.g., total available bicarbonate) resulting from delivery of dialysate to the patient (rather, merely, than on the bicarbonate contribution, e.g., of a single constituent that makes up the dialysate) and that, thereby, achieve a more physiologically appropriate dialysate mix than provided in the prior art.

Thus, the invention provides in one aspect improved methods and apparatus for hemodialysis that take into account (i) a contribution of bicarbonate contained in a bicarbonate dialysate constituent to overall available bicarbonate in a dialysate formed from that constituent, (ii) a contribution of bicarbonate resulting from metabolism of acetate contained in an acid dialysate constituent to overall available bicarbonate formed from that acid constituent, and/or (iii) a contribution of auxiliary constituent components, such as potassium, magnesium, calcium, etc., such that the auxiliary components are proportioned appropriately as to produce a dialysate of desired ionic concentration. Such methods and apparatus can be used for the administration, display and control of the various dialysate constituents and auxiliary components.

By way of example, one such method includes administering to a patient a dialysate produced through a process of (a) determining an amount of bicarbonate present in a bicarbonate dialysate constituent prescribed for administration to the patient and likely to become available bicarbonate in a dialysate produced therefrom, (b) determining an amount of acetate present in an acid dialysate constituent prescribed for administration to the patient and likely to become available bicarbonate in a dialysate produced therefrom as a result of metabolism of the aforementioned acetate, and (c) combining the acid dialysate constituent with the bicarbonate dialysate constituent in such proportion that a total of the amounts determined in (a) and (b) substantially matches a total amount of base buffer desired for administration to the patient.

Further aspects of the invention provide methods as described above in which step (a) includes determining, as the amount of bicarbonate likely to become available in the dialysate, an amount of bicarbonate present in the bicarbonate dialysate constituent dissociable in aqueous solution. Related aspects of the invention provide methods as described above in which step (b) includes determining, as the amount of acetate present in the acid dialysate and likely to become available as a result of metabolism, an amount of acetate present in the acid dialysate constituent dissociable in an aqueous solution.

Still further related aspects of the invention provide methods as described above in which step (c) further comprises combining the acid dialysate constituent with the bicarbonate dialysate constituent in such proportion that a total amount of available sodium matches a total amount of sodium desired for administration to the patient. Related aspects of the invention provide methods as described above in which step (c) further comprises combining an aqueous dialysate constituent (e.g., water) with the acid dialysate constituent and with the bicarbonate dialysate constituent in such proportion as to produce a dialysate of desired ionic concentration.

Still other aspects of the invention provide a method of hemodialysis comprising administering to a patient a dialysate produced through a process of (a) determining an amount of bicarbonate present in a bicarbonate dialysate constituent prescribed for administration to the patient and likely to become available bicarbonate in a dialysate produced therefrom, (b) determining an amount of acetate present in an acid dialysate constituent prescribed for administration to the patient and likely to become available bicarbonate in a dialysate produced therefrom as a result of metabolism of the aforesaid acetate, (c) determining an amount of sodium present in the acid dialysate constituent prescribed for administration to the patient and likely to become available sodium in a dialysate produced therefrom, (d) determining an amount of sodium present in the bicarbonate dialysate constituent prescribed for administration to the patient and likely to become available sodium in a dialysate produced therefrom, (e) combining the acid dialysate constituent with the bicarbonate dialysate constituent in such proportion that (i) a total of the amounts determined in (a) and (b) substantially matches a total amount of base buffer desired for administration to the patient, and (ii) a total of the amounts determined in (c) and (d) substantially matches a total amount of sodium desired for administration to the patient.

Related aspects of the invention provide methods as described above in which step (e) further comprises combining an aqueous dialysate constituent (e.g., water) with the acid dialysate constituent and with the bicarbonate dialysate constituent in such proportion as to produce a dialysate of desired ionic concentration. Yet further related aspects of the invention provide methods as described above and further include the process (f) determining a contribution of auxiliary constituent components, such as potassium, magnesium, calcium, etc., such that the auxiliary components are proportioned appropriately as to produce a dialysate of desired ionic concentration.

Still other aspects of the invention provide methods paralleling those described above for determining the proportions of an acid dialysate constituent, a bicarbonate dialysate constituent, and an aqueous dialysate constituent that can be combined in order to produce a dialysate having a desired amount of total available sodium and total buffer (e.g., total available bicarbonate).

Yet still other aspects of the invention provide hemodialysis machines and other apparatus for dialysate administration that produce dialysate in accordance with methods described above.

Still other aspects of the invention provide methods for dialysate administration as described above that include (a) inputting a value representing a total amount of sodium desired for administration to a patient, (b) inputting a value representing a total amount of bicarbonate desired for administration to a patient, the combination of (a) and (b) achieving a desired amount of total buffer and total sodium. The method can also, optionally, include (c) inputting a value representing a total amount of acetate in an acid dialysate constituent to be administered to a patient and/or (d) calculating a total amount of the auxiliary constituent components from the acid and bicarbonate concentrates, such as calcium, potassium, and magnesium to be administered to the patient.

These and other aspects of the invention are evident in the drawings and in the description that follows.

### BRIEF DESCRIPTION OF THE DRAWINGS

The invention will be more fully understood from the following detailed description taken in conjunction with the accompanying drawings, in which:

FIG. 1 depicts a relationship of acid and bicarbonate constituents in formation of dialysate;

FIG. 2 is a schematic showing one embodiment of a hemodialysis apparatus according to the invention;

FIG. 3 depicts a user display of the apparatus of FIG. 2 when used with liquid dialysate constituents;

FIG. 4 depicts the user display of FIG. 3 where an amount of bicarbonate has been entered by a clinician;

FIG. 5 depicts a user display of the apparatus of FIG. 2 showing an adjustment in the parameters following an increase in sodium level;

FIG. 6 depicts a user display of the apparatus of FIG. 2 showing an adjustment in the parameters following an increase in sodium level;

FIG. 7 depicts a user display of the apparatus of FIG. 2 when used with solid or dry pack dialysate constituents;

FIG. 8A depicts a user display of the apparatus of FIG. 2 showing an adjustment in the other dialysate constituent parameters when an amount of sodium and an amount of bicarbonate has been entered by a clinician;

FIG. 8B depicts a user display of the apparatus of FIG. 2 showing an adjustment in the other dialysate constituent parameters when an amount of sodium and an amount of bicarbonate has been entered by a clinician; and

FIG. 9 depicts a method according to the invention for the formation and administration of a dialysate solution.

### DETAILED DESCRIPTION OF THE INVENTION

The present invention provides methods and apparatus for administration, control, and display of amounts of dialysate constituents, particularly, for example, the acid and bicarbonate constituents, in order to achieve more physiologically desirable dialysate. In particular, by way of example, methods and apparatus according to the present invention provide for administration of dialysate based on total buffer (e.g., total available bicarbonate) resulting from delivery of combined dialysate constituents to the patient—rather, merely, than on the bicarbonate contribution of a single one of those constituents (e.g., the bicarbonate constituent alone). This is achieved in the illustrated embodiment by, for example, taking into account (i) a contribution of bicarbonate contained in a bicarbonate dialysate constituent to total buffer (e.g., total overall available bicarbonate) in a dialysate formed from that constituent, and (ii) a contribution of bicarbonate resulting from metabolism of acetate contained in an acid dialysate constituent to total buffer (e.g., total overall available bicarbonate) formed from that acid constituent. As a result, such methods and apparatus according to the invention more accurately produce, administer and/or facilitate administration of dialysate to a patient, thereby, for example, preventing acidosis and/or its alkaline equivalent in the patient.

One of the main functions carried out by normal, working kidneys, or alternatively artificial kidneys through dialysis, is the regulation of the pH of the blood. Maintenance of the correct pH in the body insures proper ionization and charge on molecules, such as amino acids. A change in charge disturbs protein structure, for example, and can lead to discomfort, sickness, and even death. Typically, the body tolerates only small changes in blood pH (6.8 to 7.6, per established medical procedure).

Commonly in dialysis, bicarbonate is used as a buffer for correction of reduced pH values (over-acidification) in dialysis patients. The bicarbonate (HCO₃)⁻ reacts with the “acidic” H⁺-ion to form neutral H₂O (water) and CO₂ (carbon dioxide) in accord with the following relation:
H⁺+HCO₃⁻<=>H₂CO₃<=>H₂O+CO₂ Eq. 1

Two significant factors in this relationship are bicarbonate ion concentration and carbon dioxide concentration, both of which play a role in determining body fluid pH. In particular, the pH of the extracellular fluid, such as dialysate, changes whenever the concentration of the bicarbonate ion or carbon dioxide changes, as shown in the Henderson-Hasselbalch equation:
pH=pKa+log [HCO3-]/[CO2] Eq. 2

The illustrated embodiment operates, in part, by capitalizing on the benefit of calculating the concentration of bicarbonate ion, in and of itself, as well as in the form of total buffer, in the dialysate solution to maintain the pH of the blood at an acceptable level.

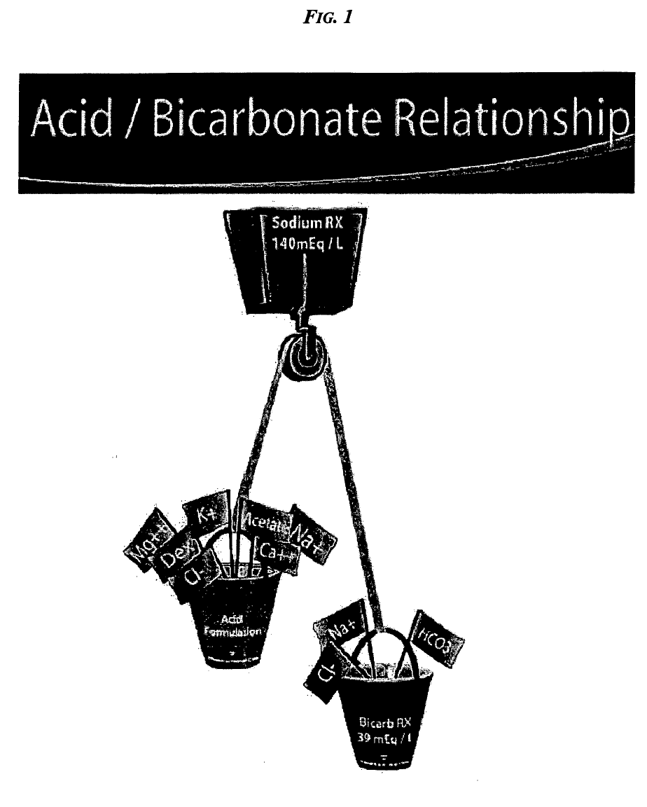

During dialysis procedures, the change in concentration of the bicarbonate ion also affects the contribution of the sodium by the acid mix, and other parameters such as potassium and calcium that affect the total amount of buffer that a patient receives, as shown in FIG. 1. Moreover, the acetic acid contained within the liquid acid constituent metabolizes in a patient's liver to form bicarbonate. This metabolism is a sufficiently efficient reaction to effect a one-to-one conversion in milliequivalents/liter. When the constituents used are dry products, such as the GRANUFLO® or NATURALYTE® mixtures (or like products available in the marketplace), a greater amount (about 4 Meq more) of sodium acetate is produced.

The present invention provides methods and apparatus that take these factors into account. In particular, methods and apparatus are provided that include administering, controlling, and effecting a display of a dialysate produced through a process involving the steps of (i) determining an amount of bicarbonate present in a bicarbonate dialysate constituent prescribed for administration to the patient and likely to become available bicarbonate in a dialysate produced therefrom, (ii) determining an amount of acetate present in an acid dialysate constituent prescribed for administration to the patient and likely to become available bicarbonate in a dialysate produced therefrom as a result of metabolism of the aforementioned acetate, and (iii) combining the acid dialysate constituent with the bicarbonate dialysate constituent in such proportion that a total of the amounts substantially matches a total amount of base buffer desired for administration to the patient.

These methods and apparatus can further include (iv) determining an amount of bicarbonate present in a bicarbonate dialysate constituent prescribed for administration to the patient and likely to become available bicarbonate in a dialysate produced therefrom, (v) determining an amount of acetate present in an acid dialysate constituent prescribed for administration to the patient and likely to become available bicarbonate as a result of metabolism of the acetate in a dialysate produced therefrom, (vi) determining a proportion of acid dialysate constituent to bicarbonate dialysate constituent, the combination of which, in view of the amounts determined above, substantially match the total amount of base buffer desired for administration to the patient.

The method and apparatus provided herein can also take into account the proportions of auxiliary dialysate constituent components, such as potassium, magnesium, calcium, etc., and effects the display and control of all of the various dialysate constituents noted above.

While the method and apparatus described herein can be used to effect a more physiologically desirable dialysate in general, they can also be used to effect sodium modeling during dialysis—that is, ensuring that an appropriate amount of water is removed from the patient's blood without removing so much as could cause physiological distress or even death. In this regard, water is drawn to sodium molecules, and the greater the amount of sodium present in a dialysate solution contributes sodium to the blood, which moves water from the tissues of said patient. While the prior art sodium modeling methods focused on the amount of total sodium in a solution, the present method and apparatus now allows a clinician (e.g., a physician or other health worker) to set, change, monitor, and maintain the total buffer concentration while sodium modeling.

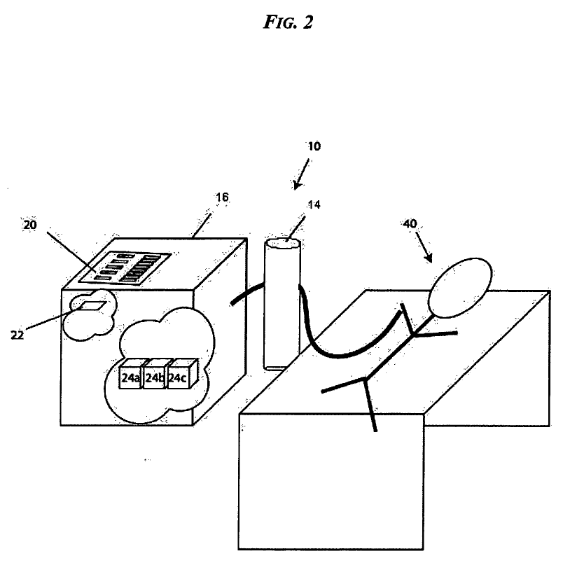

FIG. 2 depicts a hemodialysis treatment system 10 according to one practice of the invention. The system 10 includes a dialysis machine 16 connected to a dialyzer (also called an artificial kidney) 14, which in turn is coupled into the patient's bloodstream (not shown) in the conventional manner known in the art.

The dialysis machine 16 can have any configuration known in the art or otherwise that allows it to monitor and maintain blood flow throughout the system 10, as well as to administer dialysate in the conventional manner known in the art, as modified in accordance with the teachings hereof.

The illustrated dialysis machine 16 includes a processor 22 (e.g., a central processing unit, an embedded processor, or otherwise) that is coupled in the conventional manner with valves, dispensers, and other apparatus known in the art of hemodialysis for monitoring and maintaining blood flow, administering dialysate, and cleaning blood, as adapted in accordance with the teachings hereof. The dialysis machine 16 is also adapted to receive the various dialysate constituents from fluid containers or jugs 24a, 24b, 24c, e.g., in the case of liquid constituents such as sodium chloride solution, sodium acetate solution, and sodium bicarbonate solution (by way of non-limiting example), or chemical packs (not shown), e.g., in the case of dry mixes such as the aforementioned GRANUFLO® or NATURALYTE® mixtures (by way of non-limiting example), that hold and dispense the various constituents of the dialysate mixture, e.g., water, acid “mix” and bicarbonate.

The processor 22 is programmed or otherwise adapted to calculate the total buffer and/or required amounts of dialysate constituents, e.g., those stored in jugs 24a, 24b, 24c, based on an input by the clinician via a keypad, keyboard, touch screen, or any other conventional input device in accordance with the processes and administration techniques described herein. The results of the calculation, e.g., the desired parameters, are then displayed on a user display 20, which can be an LCD, diode, or any other known display type.

Having now introduced the exemplary system components, in operation, the system of FIG. 2 takes advantage of the interrelationship between the dialysate constituents and their by-products as illustrated in FIG. 1. In particular, as shown in FIG. 1, the concentration of the total amount of buffer (e.g., total bicarbonate) in the dialysate solution can be affected not only by the amount of the acid constituent (which by way of non-limiting example can be sodium), but also as a result of reaction by-products and the auxiliary components such as magnesium, potassium, and calcium. In a like manner, the concentration of the total buffer can be affected not only by the concentration of bicarbonate, but also as a result of reaction by-products such as the bicarbonate formed due to the metabolism of acetate from the acid constituent and/or the increased amount of sodium acetate if dry products are used, as well as the auxiliary components.

By taking into account the interrelationships of the dialysate constituents when calculating the constituent concentrations for a dialysate solution, a more physiologically balanced, and hence desirable, dialysate solution is formed. As a result, a clinician can more accurately produce, administer, and/or facilitate administration of dialysate to a patient, thereby preventing acidosis and/or its alkaline equivalent in the patient. This is advantageous over solutions of the prior art which determined the desired amounts of the bicarbonate and acid constituents with respect to one another and do not take into account such constituent interrelationships noted above and in FIG. 1. Thus, such prior art dialysate solutions often had higher concentrations of components, and in particular the acid component, than were physiologically desirable.

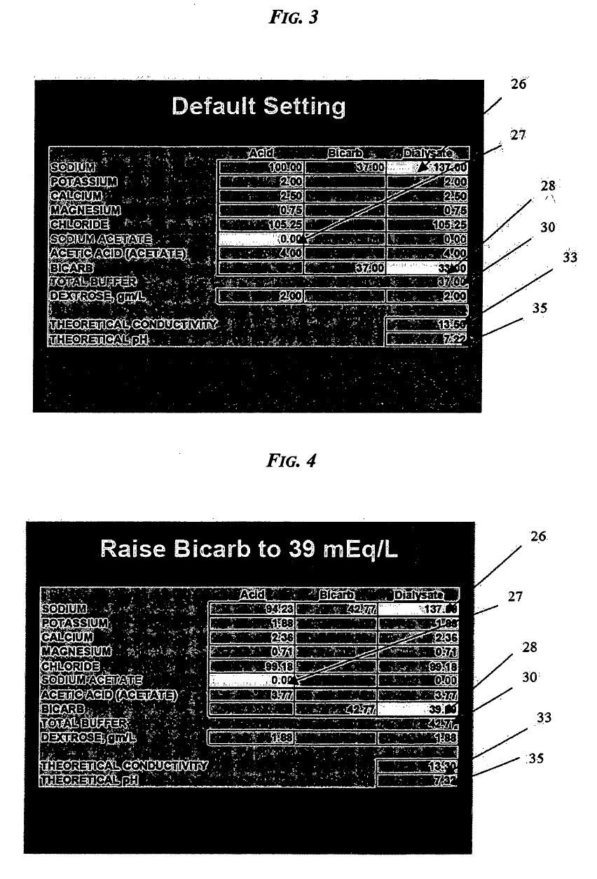

Consistent with the description above, FIGS. 3-8 depict a human-machine interface effected by processor, display and the above-mentioned input device(s), e.g., all operating in conjunction with dialyzer and that can be used with the system of FIG. 2, to (a) input a value representing a total amount of sodium desired for administration to patient, (b) input a value representing a total amount of bicarbonate desired for administration to the patient, and, optionally, (c) input a value representing a total amount of base buffer in the final dialysate to be administered to the patient, as well as to display, administer, and control determinations of appropriate dialysate constituent metering, in accord with the teachings discussed herein.

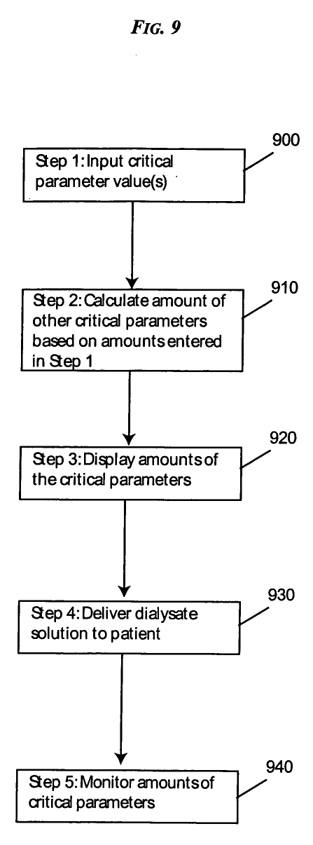

In particular, and with reference to FIG. 9, which illustrates an exemplary method of operation of the present invention, and FIG. 3, which illustrates an exemplary human-machine interface that can be used with the method illustrated in FIG. 9, in a first step of operation 900, a clinician can input a value for at least one critical parameter in an interface. By way of non-limiting example, as shown in FIG. 3, one embodiment of the present invention allows a clinician to select and/or input parameters relating to the total amount of sodium 26, bicarbonate 28, or total buffer 30 when liquid constituents are used. In an exemplary embodiment the clinician can select and/or input a value relating to the total amount of sodium 26.

In the second step of operation 910, the processor can calculate the amounts of other critical parameters to be delivered to the patient based on the amounts entered by the clinician in step 1. Referring back to FIG. 3, once the clinician selects the total amount of sodium 26, the processor can calculate the amounts of sodium acetate 27, bicarbonate 28, and other auxiliary constituent components, as well as the total amount of buffer 30 that to be administered to the patient based on the relations shown in FIG. 1 and in Equations (1) and (2), above. The calculation can be effected by programming the processor, utilizing conventional programming techniques (e.g., for modeling and/or balancing chemical reactions) otherwise known in the art, to solve for those other parameters in view of those relations. Moreover, the processor can likewise calculate the total conductivity 33 as well as the total pH 35 of the solution.

In a third step of operation 930, the processor can effect the display of the delivery amounts of the parameters entered in steps 1 and 2 on an interactive user interface. That is, as is illustrated by FIG. 3 (as well as FIGS. 4-8, which will be discussed in more detail below), the interface displays the amounts entered and calculated of such critical parameters as sodium, sodium acetate, bicarbonate, total buffer, and/or auxiliary components such as calcium, magnesium, and potassium. Moreover, the interface can also effect the display the total conductivity and/or pH of the dialysate solution. This is particularly advantageous in that the machine can be affected by a human operator acting alone.

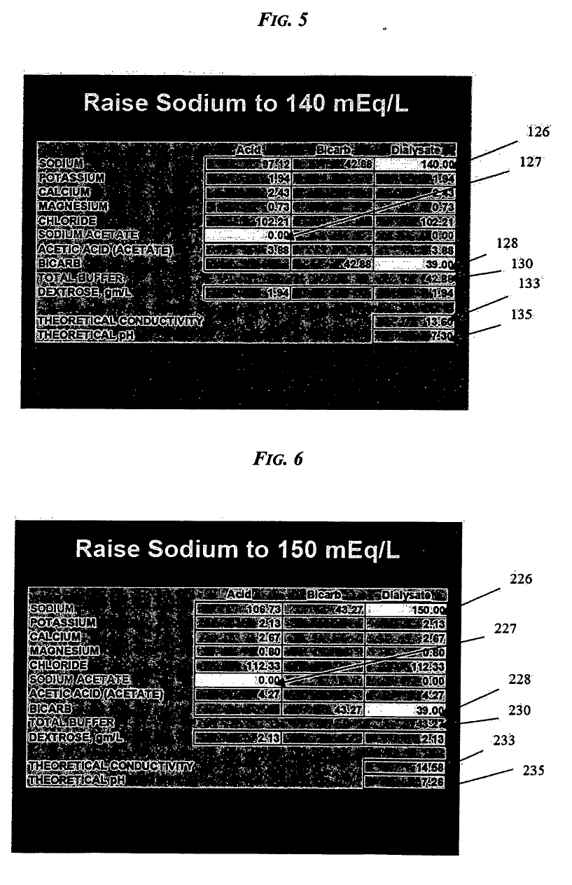

In a fourth step of operation 930, the processor can effect delivery and/or administration of the dialysate to a patient using a hemodialysis treatment system such as that shown in FIG. 2. Additionally and optionally, in a fifth step of operation 940, the processor can monitor and display in real time any one of the parameters noted above and in FIG. 1, respectively. The fifth step of operation 940 will be discussed in more detail below with respect to FIGS. 5-6.

While FIG. 3 illustrates one exemplary embodiment where a clinician selects and/or inputs a value for the total amount of sodium, it will be appreciated that other critical parameters can be inputted into the device, and the device can be used with both liquid and dry constituents. For example, in another embodiment as shown in FIG. 4, the clinician can select and/or input the desired amount of bicarbonate 30. Once selected, as noted above, the processor then calculates, as discussed in connection with step 910, and effects display of the amounts of the other reaction constituents (namely sodium 26) and by-products, as well as the total buffer 30 that will be administered to the patient.

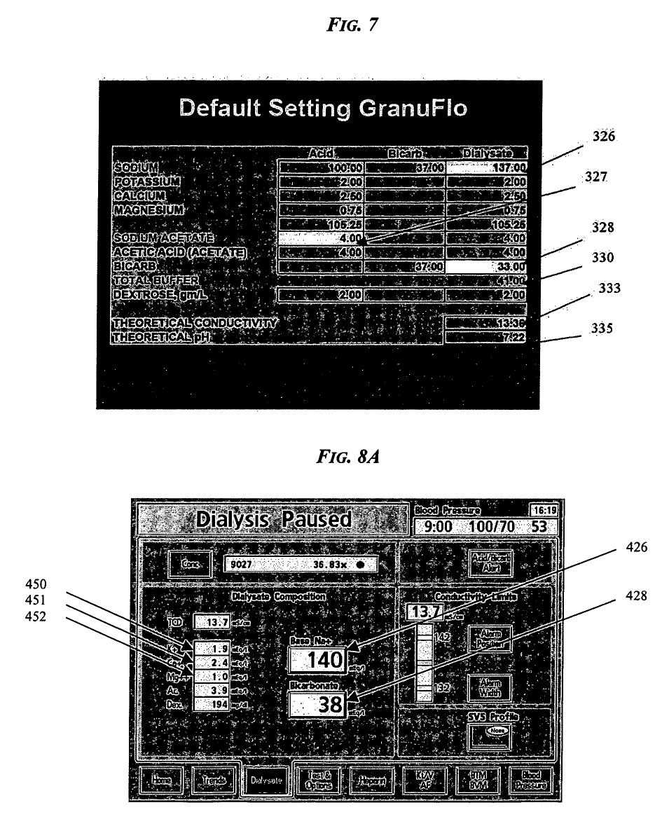

In another embodiment of the present invention, as shown in FIG. 7, a clinician can select and/or input the desired amount of sodium 326, sodium acetate 327, bicarbonate 328, and/or total buffer 330 when dry constituents such as the GRANUFLO® or NATURALYTE® mixtures are used. Once selected, the processor calculates, as discussed in connection with step 910, and effects display of the amount of the total sodium 326, sodium acetate 327, bicarbonate 328, total buffer 330, and/or other by-products that will be administered to the patient. This is particularly advantageous in that it not only takes into account the bicarbonate produced as a result of the liver's metabolism of acetate to form bicarbonate, but also accounts for the excess sodium acetate as a result of using solid or dry pack constituents. The dialysate can then be administered to a patient, in accordance with the above.

Further, and also as noted above, the processor can also calculate the total conductivity 333 and/or total pH 335 of the solution, as well as provide real time monitoring of the various constituents, reaction by-products, total buffer, conductivity, and/or pH.

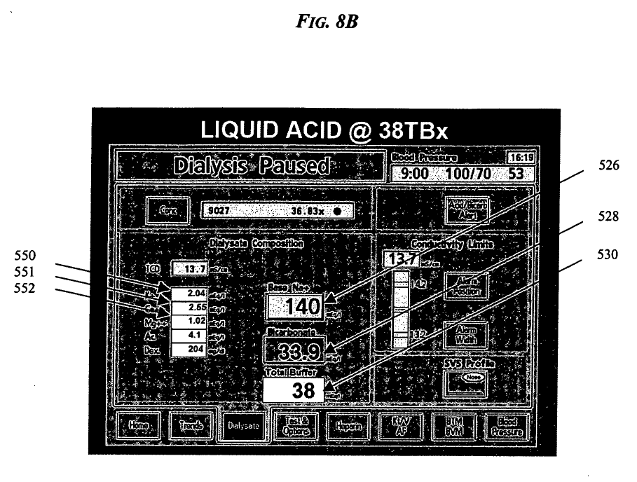

In another embodiment of the present invention, as shown in FIG. 8A, a clinician can select and/or input the desired amount of a liquid or a dry bicarbonate constituent 428 and/or total amount of a liquid or dry sodium constituent 426 to be delivered to a patient. Once selected, the processor calculates, as discussed in connection with step 910, and effects display of the amount of the auxiliary components, e.g., calcium 450, magnesium 451, and potassium 452, that will be administered to a patient with the dialysate solution. Alternatively, as shown in FIG. 8B, a clinician can select and/or input the desired amount of a liquid or a dry sodium constituent 526 and/or the desired total buffer concentration 530. Once selected, the processor calculates, as discussed in connection with step 910, and effects display of the amount of bicarbonate 528, as well as the amount of the auxiliary components, e.g., calcium 550, magnesium 551, and potassium 552, that will be administered to a patient with the dialysate solution. The dialysate can then be so administered, in accordance with the above.

FIGS. 5-6 show user displays where the amount of sodium 216, 226 increases. As the sodium concentration 126, 226 increases, the processor calculates and effects display of an adjusted amount of other constituents, such as bicarbonate 128, 228, as required to maintain a desired total buffer concentration 130, 230. Alternatively, and not shown, the processor can calculate and effect display of the change in total buffer concentration 130, 230. The processor also calculates and effects display of the total conductivity 133, 233, and/or pH 135, 235 of the dialysate solution, in accordance with the change in the sodium concentration 126, 226. By way of non-limiting example, and if the actual theoretical conductivity does not match a calculated conductivity value, the device can send visual and/or audible alarms as well as divert the solution from the patient and wait for the clinician, technician or other person to repair the system.

Following display of the adjusted amounts of constituents, the dialysate can be administered to the patient, as in accordance with the above.

A person skilled in the art will appreciate that, while the methods and apparatus are especially configured for use in hemodialysis, the methods and apparatus can be adapted for use in a variety of other medical procedures where calculating, delivering, and monitoring of solutions are required. Those of ordinary skill in the art will further understand that the methods and apparatus specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present invention. Accordingly, the invention is not to be limited by what has been particularly shown and described.

What is claimed is:

1. A method for producing dialysate, comprising:
(a) determining an amount of bicarbonate present in a bicarbonate dialysate constituent prescribed for administration to a patient and likely to become available bicarbonate in a dialysate produced therefrom;
(b) determining an amount of acetate present in an acid dialysate constituent prescribed for administration to the patient and likely to become available bicarbonate in a dialysate produced therefrom as a result of metabolism of said acetate; and
(c) combining the acid dialysate constituent with the bicarbonate dialysate constituent in such proportion that a total of the amounts determined in (a) and (b) substantially match a total amount of total base buffer desired for administration to the patient.

2. The method of claim 1, further comprising determining an amount of bicarbonate present in the bicarbonate dialysate constituent dissociable in an aqueous solution.

3. The method of claim 1, further comprising determining an amount of acetate present in the acid dialysate constituent dissociable in an aqueous solution.

4. The method of claim 1, further comprising combining the acid dialysate constituent with the bicarbonate dialysate constituent in such a proportion that a total amount of available sodium matches a total amount of sodium desired for administration to the patient.

5. The method of claim 1, further comprising combining an aqueous dialysate constituent with the acid dialysate constituent and with the bicarbonate dialysate constituent in such proportion as to produce a dialysate of desired ionic concentration.

6. The method of claim 1, further comprising calculating a resultant concentration of auxiliary components.

7. A method of hemodialysis, comprising:
administering to a patient a dialysate produced through a process of:
a) determining an amount of bicarbonate present in a bicarbonate dialysate constituent prescribed for administration to the patient and likely to become available bicarbonate in a dialysate produced therefrom;
b) determining an amount of acetate present in an acid dialysate constituent prescribed for administration to the patient and likely to become available bicarbonate in a dialysate produced therefrom as a result of metabolism of said acetate;
c) determining an amount of sodium present in an acid dialysate constituent prescribed for administration to the patient and likely to become available sodium in a dialysate produced therefrom;
d) determining an amount of sodium present in a bicarbonate dialysate constituent prescribed for administration to the patient and likely to become available sodium in a dialysate produced therefrom; and
e) combining the acid dialysate constituent with the bicarbonate dialysate constituent in such proportion that (i) a total of the amounts determined in (a) and (b) substantially matches a total amount of total base buffer desired for administration to the patient, and (ii) a total of the amounts determined in (c) and (d) substantially matches a total amount of sodium desired for administration to the patient.

8. The method of claim 7, in which step (e) further comprises combining an aqueous dialysate constituent with the acid dialysate constituent and with the bicarbonate dialysate constituent in such a proportion as to produce a dialysate of desired ionic concentration.

9. The method of claim 7, further comprising determining an amount of at least one of bicarbonate present in the bicarbonate dialysate constituent and acetate present in the acid dialysate constituent dissociable in an aqueous solution.

10. (canceled)

11. The method of claim 7, further comprising combining the acid dialysate constituent with the bicarbonate dialysate constituent in such proportion that a total amount of available sodium matches a total amount of sodium desired for administration to the patient.

12. The method of claim 7, further comprising combining an aqueous dialysate constituent with the acid dialysate constituent and with the bicarbonate dialysate constituent in such proportion as to produce a dialysate of desired ionic concentration.

13. The method of claim 7, further comprising calculating and determining a resultant concentration of auxiliary components.

14. A method for dialysate administration, comprising:
(a) inputting a value representing a total amount of sodium desired for administration to a patient; and
(b) inputting a value representing a total amount of bicarbonate desired for administration to the patient.

15. The method of claim 14, further comprising (c) inputting a value representing a total amount of acetate in an acid dialysate constituent.

16. The method of claim 14, further comprising:
(d) determining an amount of bicarbonate present in a bicarbonate dialysate constituent prescribed for administration to the patient and likely to become available bicarbonate in a dialysate produced therefrom;
(e) determining an amount of acetate present in an acid dialysate constituent prescribed for administration to the patient and likely to become available bicarbonate as a result of metabolism of the acetate in a dialysate produced therefrom;
(f) determining a proportion of acid dialysate constituent to bicarbonate dialysate constituent, the combination of which, in view of the amounts determined in (a) and (b), substantially match the total amount of base buffer desired for administration to the patient; and
(g) any of displaying a result of the determination in step (f) and administering a dialysate produced from such proportions.

17. The method of claim 14, further comprising calculating and determining a resultant concentration of auxiliary components.

18-19. (canceled)

20. The method of claim 14, further comprising:
(d) determining an amount of sodium present in a bicarbonate dialysate constituent prescribed for administration to the patient and likely to become overall available sodium in a dialysate produced therefrom;
(e) determining an amount of sodium present in an acid dialysate constituent prescribed for administration to the patient and likely to become available sodium in a dialysate produced therefrom;
(f) determining a proportion of acid dialysate constituent to bicarbonate dialysate constituent, the combination of which, in view of the amounts determined in (a) and (b), substantially match the total amount of dialysate desired for administration to the patient; and
(g) any of displaying a result of the determination in step (f) and administering a dialysate produced from such proportions.

21. (canceled)

22. Apparatus for hemodialysis comprising
A. an interface that accepts values representing one or more of (a) a total amount of sodium desired for administration to a patient, and (b) a total amount of buffer desired for administration to the patient,
B. a processor that determines
(i) an amount of bicarbonate present in a bicarbonate dialysate constituent prescribed for administration to a patient and likely to become available bicarbonate in a dialysate produced therefrom;
(ii) an amount of acetate present in an acid dialysate constituent prescribed for administration to the patient and likely to become available bicarbonate in a dialysate produced therefrom as a result of metabolism of said acetate by the patient;
C. the apparatus effecting delivery to a patient of a combination the acid dialysate constituent with the bicarbonate dialysate constituent in such proportion that a total of the amounts determined by the processor in B(i) and B(ii) substantially match a total amount of total base buffer desired for administration to the patient.

23. The apparatus of claim 22, wherein the interface displays any of an amount determined by the processor in B(i), an amount determined by the processor in B(ii), and the proportion of acid dialysate constituent to bicarbonate dialysate constituent delivered to the patient.

24. The apparatus of claim 22, wherein
D. the processor additionally determines
(i) an amount of sodium present in an acid dialysate constituent prescribed for administration to the patient and likely to become available sodium in a dialysate produced therefrom,
(ii) an amount of sodium present in a bicarbonate dialysate constituent prescribed for administration to the patient and likely to become available sodium in a dialysate produced therefrom.

25. The apparatus of claim 24, wherein the apparatus effects delivery to a patient of a combination the acid dialysate constituent with the bicarbonate dialysate constituent in such proportion that a total of the amounts determined by the processor in B(i) and B(ii) substantially match a total amount of total base buffer desired for administration to the patient, and such that a total of the amounts determined in D(i) and D(ii) substantially matches a total amount of sodium desired for administration to the patient.

26. (canceled)

27. The apparatus of claim 22, wherein the processor determines an amount of at least one of bicarbonate present in the bicarbonate dialysate constituent and acetate present in the acid dialysate constituent dissociable in an aqueous solution.

28. The apparatus of claim 22 which effects combination of the acid dialysate constituent with the bicarbonate dialysate constituent in such a proportion that a total amount of available sodium matches a total amount of sodium desired for administration to the patient.

29. The apparatus of claim 22 which effects combination of an aqueous dialysate constituent with the acid dialysate constituent and with the bicarbonate dialysate constituent in such proportion as to produce a dialysate of desired ionic concentration.

30. The apparatus of claim 25, wherein the interface displays any one of an amount determined by the processor in B(i), an amount determined by the processor in B(ii), an amount determined by the processor in D(i), an amount determined by the processor in D(ii), and the proportion of acid dialysate constituent to bicarbonate dialysate constituent delivered to the patient.
